(19) United States
(12) Patent Application Publication
(10) Pub. No.: US 2006/0283802 A1
(43) Pub. Date: Dec. 21, 2006

(54) Methods and systems for producing electricity and desalinated water

(75) Inventor: Andrew W. Gordon, Boca Raton, FL (US)

Correspondence Address: RUDEN, MCCLOSKY, SMITH, SCHUSTER & RUSSELL, P.A., 222 LAKEVIEW AVE, SUITE 800, WEST PALM BEACH, FL, 33401-6112, US

(73) Assignee: Water Standard Company, LLC

(21) Appl. No.: 11/471,747

(22) Filed: Jun. 20, 2006

Related U.S. Application Data
(60) Provisional application No. 60/692,374, filed on Jun. 21, 2005.

(51) Int. Cl. C02F 1/44; B01D 61/02

(52) U.S. Cl. 210/652; 210/747; 203/10; 210/242.1; 210/321.6; 210/184; 210/257.2

(57) ABSTRACT

The heated exhaust from a gas turbine-powered electrical generator mounted on a structure positioned offshore on the surface of a body of water is transferred to water to be desalinated to aid in the desalination process by providing heat for distillation or by raising the temperature of water to be desalinated to a temperature more suitable for efficient desalination by reverse osmosis or another method. The electricity produced by the generator and the desalinated water produced by the desalination system are conveyed to a land-based distribution center for use on land. Concentrate produced by the desalination system can be diluted prior to discharge into the body of water to reduce the impact on the environment.

### CROSS-REFERENCE TO RELATED APPLICATION

The present application claims the priority of U.S. provisional patent application No. 60/692,374 filed Jun. 21, 2005.

### FIELD OF THE INVENTION

The invention relates to facilities, systems, and methods for producing electricity and desalinating water.

### BACKGROUND

Production of electrical power for use in a community can be accomplished by any one of a number of known methods and systems. Among the most efficient of these is the use of gas turbine electrical generators—which can be up to 60% or more efficient with the major source of energy loss being the waste heat expelled from the generator in the combustion exhaust. Undesirable side-effects of operating a gas turbine electrical generator include heat production, noise, vibration, odor, or aesthetics. Gas turbine-based electrical power plants are therefore preferably located in the industrialized areas of a community or in areas remotely located from residential areas.

### SUMMARY

The invention relates to the development of facilities, systems, and methods for producing electrical power using a gas turbine electrical generator and for re-directing the heat energy in the exhaust produced by the gas turbine for use in desalinating water. The invention is particularly well-suited for those systems and methods utilizing desalination components located off-shore such as those described in U.S. patent application Ser. Nos. 10/630,351, 10/734,050, 11/114,721, and 60/778,131. Such desalination methods and systems are advantageous over conventional land-based desalination systems because they allow water shortage problems to be addressed in most areas throughout the world while minimizing (i) the amount of fixed infrastructure required, (ii) the amount of valuable shore-side land required, and (iii) the impact on the environment caused by local discharge of desalination waste products such as heat and concentrated saline. The combination of off-shore gas turbine electrical production with off-shore water desalination provides flexibility in locating and re-locating electrical power plant facilities, and also allows the heat energy in the gas turbine exhaust, which would normally be lost to the surrounding environment, to be used to heat water in the desalination process. Accordingly, the overall efficiency of the integrated electricity production/water desalination system is higher than non-integrated electricity production and desalination systems. Moreover, in those arrangements of the invention where components of the electricity production system and water desalination system are shared (e.g., fuel systems, systems for communication with a land-based center), additional efficiencies can be achieved. The systems and methods of the invention can also include other energy-saving devices and systems, such as isobaric pressure exchangers (Energy Recovery, Inc., SanLeandro, Calif.), pelton wheels, and turbine energy-saving systems to lower overall production energy demands.

Accordingly, the invention features a system including: a structure (e.g., a hulled sea-going vessel or an anchored platform) positioned on the surface of a body of water (e.g., an ocean, sea, river, or lake); a gas turbine-powered electrical generator mounted on the structure and capable of producing electricity and a heated exhaust; a desalination system mounted to the structure and including a container for holding water to be desalinated, an inlet for intaking water to be desalinated, and an outlet for discharging water that has been desalinated; and a space through which the heated exhaust can be directed to the container.

In some variations of the system of the invention, the structure is positioned on the surface of the body of water at least 1 km from the nearest point of land.

The gas turbine-powered electrical generator of the system can include (or otherwise be arranged to run on) a fuel such as natural gas, kerosene, diesel, combined diesel and natural gas, or a biofuel, and can be capable of producing at least 1000 kW (kilowatt) (e.g., 900 kW, 1000 kW, 2000 kW, 3000 kW, 4000 kW, 5000 kW, 10,000 kW, 50,000 kW, 100,000 kW, 200,000 kW, 300,000 kW, 400,000 kW, 500 megawatt (MW)) of electrical power.

The desalination system of the system can include a water distillation apparatus and/or reverse osmosis membrane.

The space through which the heated exhaust can be directed to the container can be one within a tube (e.g., with one or more bends in it).

The system of the invention can also include a land-based electricity distribution center in electrical communication with the gas turbine-powered electrical generator and/or a land-based desalinated water distribution center in fluid communication with the desalination system. In those systems, including both a land-based electricity distribution center and a land-based desalinated water distribution center, the two centers can be located less than 1 kilometer (km) apart.

The desalination system component of the system of the invention can further include a concentrate dilution system in which a concentrate produced in the desalination system can be diluted to yield a diluted concentrate prior to discharge into the body of water. The dilution system can include a concentrate dilution container, an inlet for introducing concentrate into the dilution container, an inlet for introducing water from the body of water into the space, and an outlet for discharging the diluted concentrate from the container.

Another aspect of the invention is a method including the steps of: (a) producing electricity and a heated exhaust by operating a gas turbine-powered electrical generator mounted on a structure positioned offshore on the surface of a body of water; and (b) on the structure, transferring heat from the heated exhaust to water to be desalinated.

The step of transferring heat from the heated exhaust to water to be desalinated can cause the water to be desalinated to vaporize, and the vaporized water can be condensed to a liquid.

The method of the invention can further include the steps of: (c) conveying the produced electricity from the gas turbine-powered electrical generator mounted on a structure to a land-based desalinated electricity distribution center; (d) on the structure, desalinating the water to be desalinated; and (e) conveying the desalinated water from the structure to a land-based desalinated water distribution center.

In the method of the invention, the step of desalinating water can yield a concentrate and the method can further include the steps of: (f) diluting the concentrate to yield a diluted concentrate; and (g) discharging the diluted concentrate into the body of water.

Unless otherwise defined, all technical terms used herein have the same meaning as commonly understood by one of ordinary skill in the art to which this invention belongs. Although methods, materials and materials similar or equivalent to those described herein can be used in the practice or testing of the present invention, suitable methods and materials are described below. All publications, patent applications, patents, and other references mentioned herein are incorporated by reference in their entirety. In the case of conflict, the present specification, including definitions will control. In addition, the particular embodiments discussed below are illustrative only and not intended to be limiting.

### BRIEF DESCRIPTION OF THE DRAWINGS

FIG. 1 is a perspective view of a system of the invention.

FIG. 2A is a side view of a sea-going vessel of the system of the invention including a gas turbine electrical generator and a desalination system in a first arrangement.

FIG. 2B is a side view of a sea-going vessel of the system of the invention including a gas turbine electrical generator and a desalination system in a first arrangement.

### DETAILED DESCRIPTION

The present invention provides systems and methods for producing electricity and a heated exhaust by operating a gas turbine-powered electrical generator mounted on a structure positioned offshore on the surface of a body of water. On the structure, heat is transferred from the heated exhaust to water to be desalinated to aid in the desalination process by providing heat for distillation or by raising the temperature of water to be desalinated to a temperature more suitable for efficient desalination by reverse osmosis or another method. The electricity produced by the generator is conveyed to a land-based desalinated electricity distribution center for use on land, and the desalinated water produced by the desalination system is conveyed to a land-based desalinated water distribution center for use on land. Concentrate produced by the system can be diluted prior to discharge into the body of water to reduce the impact on the environment.

The below described preferred embodiments illustrate adaptation of these systems and methods. Nonetheless, from the description of these embodiments, other aspects of the invention can be made and/or practiced based on the description provided below.

### System for Producing Electricity and Desalinated Water

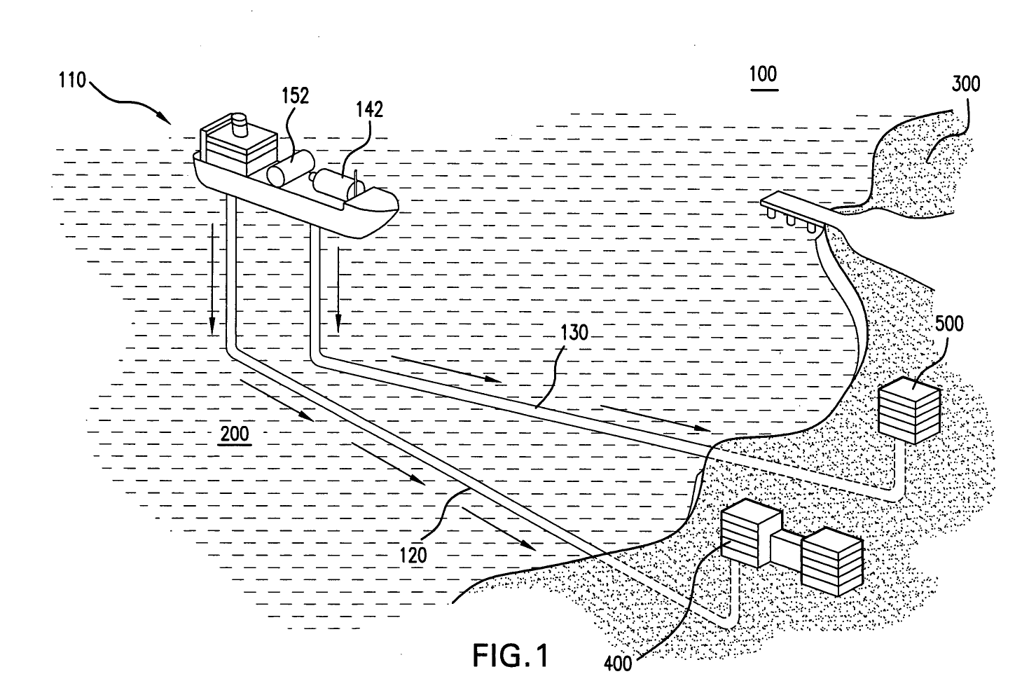

Referring now to FIG. 1, a system 100 for producing electricity and desalinated water is shown as including a structure 110 shown positioned on a body of water 200 at some distance from the shore 300, a land-based electricity distribution center 400 electrically connected to the structure 110 via an electrically conductive cable 120, and a land-based desalinated water distribution center 500 fluidly connected to the structure 110 via a conduit 130.

The structure 110 positioned on a body of water 200 is shown as a sea-going vessel. Suitable sea-going vessels that might be used as the structure 110 include a ship, a barge, a series of interconnected ships and/or barges. Preferred sea-going vessels include single hull tanker vessels that were designed and built to transport cargo such as cargo containers, oil, and automobiles that have been retrofitted for housing the systems for producing electricity and desalinated water described herein. Such retrofitted tankers are preferred because of their low cost associated with their abundant supply and a lack of demand for these tankers, as they are being continually phased out for oil transport. In some embodiments, however, a sea-going vessel specifically designed and built for housing the systems for producing electricity and desalinated water described herein is used. In a typical embodiment, the sea-going vessel is a tanker vessel that is moored to the floor of the body of water 200 by a turret mooring system.

Although the use of a sea-going vessel for the structure 110 is preferred because of its mobility and ease of construction (i.e., the vessel can be built at any suitable shipyard in an industrialized country and moved from the shipyard to the place of use), the structure might also take another form such as an offshore platform anchored to the floor of the body of water 200. The structure 110 may be self-propelled, non-self propelled, manned, or unmanned. In the system 100, the structure 110 can be traveling or drifting through the water or it can be moored or anchored to the floor of the body of water 200.

The body of water 200 can be any suitable for operation of system 100. Examples of such include bodies of fresh water, bodies of salt water, bodies of brackish water, oceans, seas, bays, lakes, and rivers.

In FIG. 1 the structure 110 is shown positioned on a body of water 200 at some distance from the shore 300. The exact distance chosen can vary considerably depending on the characteristics of the particular system desired for a given application and the local geography. For example, positioning the structure 110 on the body of water 200 near the shore 300 (e.g., less than about 1 km, 750 m, 500 m, 250 m, 100 m, or 50 m) is preferred for cost reasons (e.g., less infrastructure to convey fuel, supplies, crew, electricity, and water to or from the structure 110). Alternatively, positioning the structure 110 on the body of water 200 further from the shore 300 (e.g., more than about 1 km, 1.5 km, 2 km, 3 km, 5 km, 10 km or 20 km) might be preferred to: mitigate environmental damage caused by operating the system 100 (e.g., discharging waste concentrate or heat further out at sea moves the pollutants further from the shore and may help disperse the pollutants); avoid noise, vibration, odor, etc.; and/or to avoid the unaesthetic placement of an industrial complex near the shore 300.

The land-based electricity distribution center 400 can take the form of any facility that can distribute electricity received from the structure 110 to one or more electricity consuming devices (e.g., residences, commercial operations, etc.). It can be positioned at or near the shore 300 or at some distance away from the shore (e.g., greater than about 0.5, 1, 2, 3, 5, 10 km). The electrically conductive cable 120 is preferably a subsea cable including an electrically conductive metal such as copper. It may also take the form of any other device suitable for conveying electrical power and capable of transferring the electricity produced on the structure 110 (e.g., having the capacity to transfer 1-500 MW). Electricity produced on the structure 110 can be transferred to a land-based electricity distribution center 400 via a single cable, or two or more cables. Typically, the land-based electricity distribution center 400 has electrical conversion and grid transfer equipment.

The land-based desalinated water distribution center 500 can take the form of any facility that is capable of distributing desalinated water received from the structure 110 to one or more water consuming devices (e.g., residences, commercial operations, etc.). The land-based desalinated water distribution center 500 can be located in close proximity to the electricity distribution center 400 (e.g., within about 1 km) or it can located further away from the electricity distribution center 400 (e.g., more than about 1 km, 1.5 km, 2.0 km, 3.0 km, 5.0 km, 10 km, 50 km).

Water distribution center 500 is fluidly connected to the structure 110 via the conduit 130 which can take the form of any device capable of transporting water from the structure 110 to the water distribution center 500. For example, the conduit 130 can be a pipeline. Several types of pipelines are known, including floating, seafloor embedded, and seafloor stabilized pipelines. Floating pipelines to transfer oil are known, and can be constructed of known buoyant materials or can be coupled with buoyant floats disposed along its length. A floating pipeline can float on the surface of the water, or can be partially submerged below the surface of the water. A seafloor stabilized pipeline is disposed primarily below the surface of the water and rests on the floor of the body of water. A seafloor stabilized pipeline can have a plurality of weights distributed over its length to keep it generally in place or can be securely fixed to the floor of the body of water with known anchorage devices and methods. A seafloor embedded pipeline is disposed primarily below the surface of the floor of the body of water and is typically secured in place by the floor. A seafloor embedded pipeline can be buried several inches below a surface of the floor, or can be secured by anchorage devices.

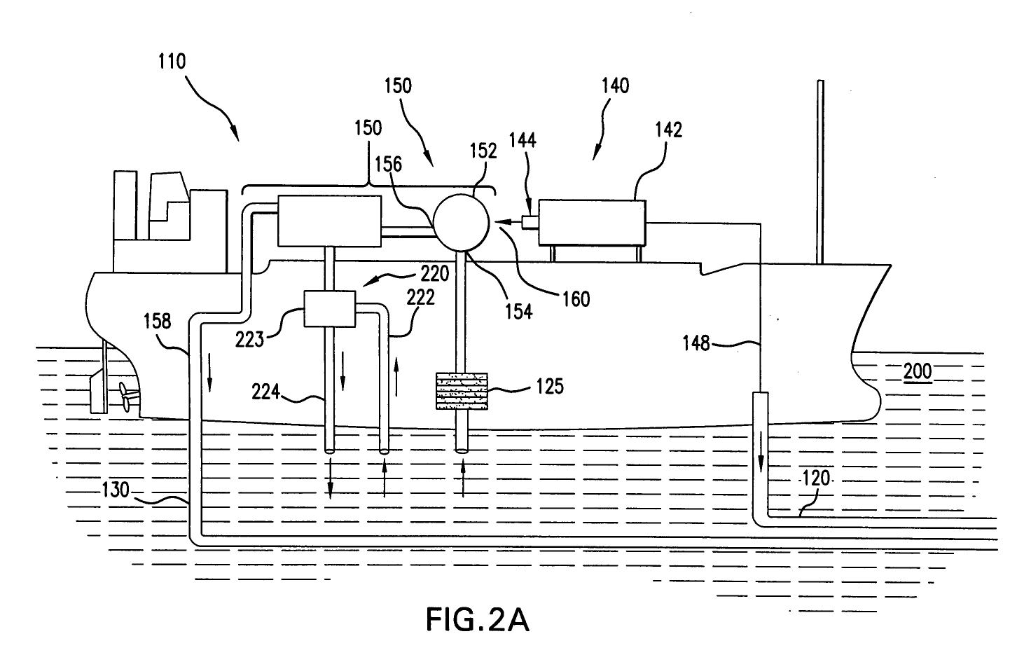

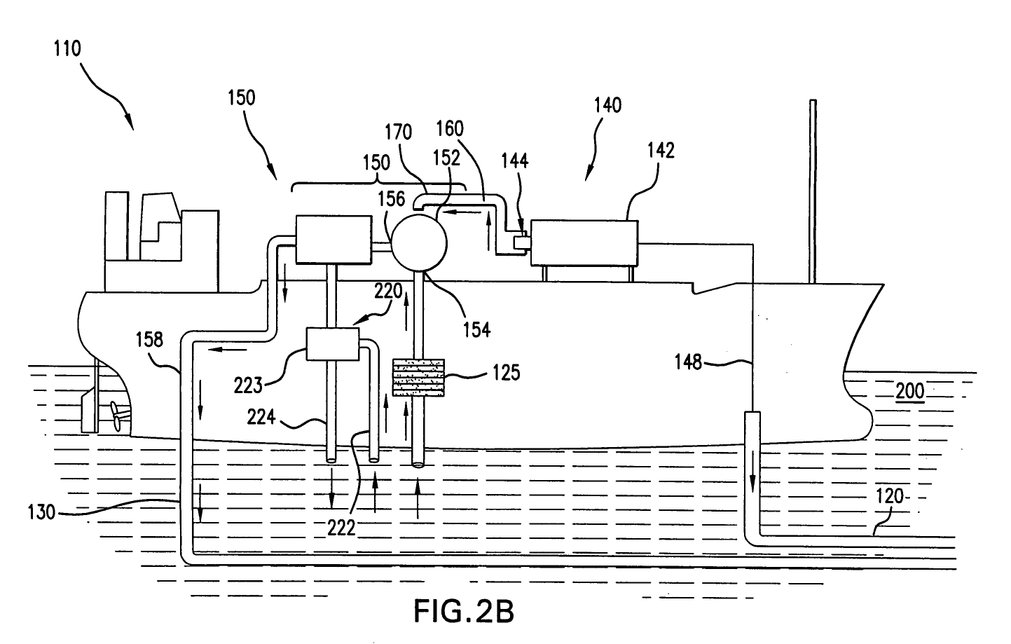

Referring now to FIG. 2A, the structure 110 is shown including a gas turbine-powered generator 140 including electricity producing component 142 and an exhaust outlet 144; and a desalination system 150 including a container 152 for holding water to be desalinated, an inlet 154 for intaking water to be desalinated, and an outlet 156 for discharging water that has been desalinated. A prefilter 125 for removing larger debris from the water to be desalinated before the desalination step is also shown. The generator 140 in FIG. 2A is shown mounted on the vessel 110 with the exhaust outlet 144 directed through a space 160 through which the heated exhaust can be applied to the container 152 for holding water to be desalinated. In this manner exhaust heat resulting from the operation of generator 140 is used to heat water in the container 152 to assist in the desalination process, e.g., to provide heat to vaporize the water to be desalinated in a distillation process, to provide heat to increase the temperature of water to be desalinated to a more efficient temperature for reverse osmosis, or to provide heat to be used (e.g., in a steam engine) to provide power for operating a reverse osmosis-based desalination system.

In an alternative embodiment, referring to FIG. 2B, the space 160 through which the heated exhaust is directed is wholly or partially enclosed with a heat-resistant tube 170 that directs the exhaust in the direction of the tube 170 (e.g., in the same direction as would occur in the absence of the tube 170 or in a different direction as determined by the positioning of the tube 170). The use of the tube 170 to channel the heated exhaust through a particular space is preferred for those arrangements of the structure 110 that preclude orienting the exhaust outlet 144 directly apposing the container 152. The tube 170 can have one or more bends to facilitate this.

The gas turbine-powered electrical generator 140 is preferred for use in the system 110 because of its relatively high energy efficiency. Numerous different gas turbines outfitted or modifiable to produce electricity and heat exhaust that are suitable for use in the invention are known and commercially available. For example, GE (Atlanta, Ga.) markets a Frame 9FB engine as well as the LM2500 Gas Turbine, Rolls Royce (Houston, Tex.) markets a 501 series gas turbine, and Centrax (Newton Abbot, England) markets the 501 series (e.g., 501-KB3, 501-KB5, 501-KN5, 501-KH5, 501-KB7, and 501-KN7) of gas turbine-powered generators. The power production capacity of the gas turbine-powered electrical generator 140 can be any suitable for use in the system 110 and can be selected based on the requirements of a particular application. As an example, the gas turbine-powered electrical generator 140 can be capable of producing between about 1 and 500 MW (e.g., 0.9, 1, 2, 3, 5, 10, 15, 20, 25, 50, 100, 200, 300, 400, 500, or 550 MW).

The gas turbine-powered electrical generator 140 can be configured to run on any suitable fuel source, e.g., a combustible liquid or gas. Examples of suitable fuels include biofuels (i.e., fuels such as ethanol or methanol that are produced at least in past from biomass such as plants, straw, or biomass waste streams); petroleum-based fuels such as diesel fuel, jet fuel, kerosene, and gasoline; gases such as propane or natural gas; liquefied coal products, etc.

Although the use of a gas turbine is preferred in most applications of the invention, in alternative embodiments of the invention, another device capable of producing electrical energy and heat in the form suitable for heating water (e.g., an internal combustion engine or a nuclear reactor) might be used in place of the gas turbine-powered generator 140.

The electricity producing component 142 of the generator 140 can be any device capable of converting energy created from the flow of combustion gases in a gas turbine into an electrical current (e.g., alternating current or direct current). The electricity producing component 142 is in electrical communication with the electrically conductive cable 120. In addition to being transferred to a land-based electricity distribution center 400, electricity produced on the structure 110 can be directed to power functions and systems on the structure 110, such as, for example, a propulsion device or a control system.

The system 100 can also include other components to facilitate the transfer of electricity from the generator 140 to the land-based electricity distribution center 400. For example, to reduce the loss of power that occurs during transmission of electricity, a step-up transformer can be interposed between the electricity producing component 142 and the electrically conductive cable 120 to increase the voltage of the electricity while it is being transferred to the land-based electricity distribution center 400. A step-down transformed can then be used downstream of the electrically conductive cable 120 to reduce the voltage as desired.

The desalination system 150 can take the form of any device or system capable of removing salt from water and being mounted on the structure 110. A number of different desalination systems are known in the art. Most are based on either distillation or reverse osmosis. Distillation systems are preferred for use in the invention because exhaust heat from the generator 140 can be easily directed to the container 152 to vaporize the water to be desalinated. Reverse osmosis systems are preferred for in some cases to increase the efficiency of the desalination process and are well known.

Referring now to the embodiments shown in FIGS. 2A and 2B, the desalination system 150 includes a prefilter 125, the container 152 for holding water to be desalinated, the inlet 154 for intaking water to be desalinated into the container 152, and the outlet 156 for discharging water that has been desalinated out of container 152. A distillation apparatus or reverse osmosis apparatus is interposed between the outlet 156 and a desalinated water discharge pipe (shown in fluid communication with the conduit 130).

Various distillation devices can be used in the desalination system 150. These include multi-stage flash (MSF), multiple effect (MED), vapor compression (VC) and waste-heat evaporators. Methods and apparatuses for performing distillation are described in Kister, Henry Z. Distillation Design, 1^{st} ed., 1992, McGraw-Hill, (New York, N.Y.) and Perry, Robert H. and Green, Don W. Perry's Chemical Engineer's Handbook, 6^{th} ed., 1984, McGraw-Hill (New York, N.Y.).

Various reverse osmosis systems can also be used in the desalination system 150. Such reverse osmosis systems can include a high pressure pump and a reverse osmosis membrane wherein the high pressure pump is operable to force the water to be desalinated through the reverse osmosis membrane. Reverse osmosis systems are described, for example, in Reverse Osmosis and Nanofiltration (Awwa Manual) by AWWA (American Water Works Association, Denver, Colo.); 1st ed edition, 1998; and Reverse Osmosis Technology (Chemical Industries), by Bipin S. Parekh (editor), Marcel Dekker (Florence, Ky.), 1988.

In some embodiments, the desalination system 150 can include a reverse osmosis system in combination with a distillation apparatus.

Generally, the desalination system 150 is capable of producing at least about 5,000 to about 450,000 (e.g., 4,500; 5,000; 10,000; 20,000; 50,000; 100,000; 250,000; 450,000; and 500,000) cubic meters of desalinated water per day. The amount of desalinated water the system 100 is capable of producing depends on the type of desalination system 150 used, the size of the structure 110, and in the case of a desalination system 150 powered by a gas turbine electrical generator, the type of generator and its electrical output.

The container 152 for holding water to be desalinated can be any suitable device in which heat can be applied to water contained therein. Generally, it will be constructed to withstand high pressure and high temperatures. It may be constructed of stainless steel or another high strength, high melting point metal or alloy. The tube 170 is similarly generally constructed of a high strength material able to withstand high temperatures, e.g., stainless steel or another high strength, high melting point metal or alloy.

The structure 110 can also include a concentrate dilution system 220 for diluting the concentrate produced from operating desalination system 150 prior to its discharge into the body of water 200. The concentrate dilution system 220 can take the form of any system or device capable of diluting concentrate aboard the structure 150 prior to its discharge. Referring to FIGS. 2A and 2B, the concentrate discharge system 220 is shown including a concentrate dilution container 223, an inlet 222 for introducing water from the body of water into the concentrate dilution container 223, an inlet for introducing concentrate into the container 223, and an outlet 224 for discharging the diluted concentrate from the concentrate dilution container 223. Pumps and valves can be used to control the movement of water and diluted concentrate through the system 220. Mixers can also be employed to assist in the dilution process. To dilute the concentrate prior to discharge, water from the body of water 200 is taken into the concentrate dilution container 223 via the inlet 222 and mixed with concentrate taken into the container 223 via the an inlet for introducing concentrate. The resulting diluted concentrate is then discharged out of the container 223 into the body of water 200 via the outlet 224. Typically, before being discharged from the structure 110, the concentrate is diluted with water from the body of water at a ratio of at least 1:1 (e.g., 1:1, 1:10, 1:100, 1:1000, etc.).

### Method of Producing Electricity and Desalinating Water

The invention provides methods of producing electricity and desalinating water. A method according to the invention includes the steps of producing electricity and a heated exhaust by operating a gas turbine-powered electrical generator mounted on a structure positioned on the surface of a body of water, and on the structure, transferring heat from the heated exhaust to water to be desalinated. Transferring heat from the heated exhaust to water to be desalinated can be used to cause the water to be desalinated to vaporize and to be condensed to a liquid (i.e., desalinated water produced by distillation) or it can be used to heat water to be desalinated to a temperature more efficient for desalination via reverse osmosis. The heat can also be used to power an engine (e.g., a steam engine) whose produced power can be used to provide force required for reverse osmosis-mediated desalination.

Methods of the invention can further include the steps of conveying the produced electricity from the gas turbine-powered electrical generator mounted on a structure to a land-based desalinated electricity distribution center; on the structure, desalinating the water to be desalinated; and conveying the desalinated water from the structure to a land-based desalinated water distribution center. The methods of the invention can also include the step of diluting a concentrate produced by the desalination process prior to discharge into a body of water.

In the embodiments shown in FIGS. 1, 2A, and 2B, electricity and desalinated water are produced by the system 100 by operating gas turbine-powered generator 140 that is mounted to the structure 110 positioned on the surface of a body of water 200. Specifically, via electricity producing component 142, operation of gas turbine-powered generator 140 converts the energy in the flow of combustion gases directly into electrical current. The exhaust heat produced by operation of gas turbine-powered generator 140 is then used to aid in the desalination process. For example, as shown in FIG. 2A, heated exhaust emitted by the gas turbine-powered generator 140 is directed onto the container 152 for holding water to be desalinated of the distillation apparatus. The water heated in this manner is then desalinated in a desalination system 150 including the distillation apparatus and/or a reverse osmosis system as described above. The electrical current and desalinated water produced are transferred to land-based distribution centers (for electricity and water, respectively) by the methods described above, while the diluted concentrate is discharged from the structure 110 into the water 200 surrounding the vessel by the methods and systems described above.

While the above specification contains many specifics, these should not be construed as limitations on the scope of the invention, but rather as examples of preferred embodiments thereof. Accordingly, the scope of the invention should be determined not by the embodiments illustrated, but by the appended claims and their legal equivalents.

What is claimed is:

1. A system comprising:
a structure positioned on the surface of a body of water;
a gas turbine-powered electrical generator mounted on the structure and capable of producing electricity and a heated exhaust;
a desalination system mounted to the structure, the desalination system comprising a container for holding water to be desalinated, an inlet for intaking water to be desalinated, and an outlet for discharging water that has been desalinated; and
a space through which the heated exhaust can be directed to the container.

2. The system of claim 1, wherein the structure is a sea-going vessel comprising a hull.

3. The system of claim 1, wherein the structure is a platform anchored to the floor of the body of water.

4. The system of claim 1, wherein the body of water is an ocean or a sea.

5. The system of claim 1, wherein the structure is positioned on the surface of the body of water at least 1 km from the nearest point of land.

6. The system of claim 1, wherein the gas turbine-powered electrical generator comprises a fuel selected from the group consisting of biofuel, natural gas, kerosene, diesel, and combined diesel and natural gas.

7. The system of claim 1, wherein the gas turbine-powered electrical generator is capable of producing at least 1 MW of electrical power.

8. The system of claim 1, wherein the desalination system comprises a water distillation apparatus.

9. The system of claim 1, wherein the desalination system comprises a reverse osmosis membrane.

10. The system of claim 1, wherein the space through which the heated exhaust can be directed to the container is comprised within a tube.

11. The system of claim 11, wherein the tube comprises at least one bend.

12. The system of claim 1, further comprising:
a land-based electricity distribution center and an electrically conductive cable electrically connecting the gas turbine-powered electrical generator to the land-based electricity distribution center.

13. The system of claim 1, further comprising:
a land-based desalinated water distribution center and a conduit fluidly connecting the desalination system to the land-based water distribution center.

14. The system of claim 1, further comprising:
a land-based electricity distribution center and an electrically conductive cable electrically connecting the gas turbine-powered electrical generator to the land-based electricity distribution center; and
a land-based desalinated water distribution center and a conduit fluidly connecting the desalination system to the land-based water distribution center,
wherein the land-based electricity distribution center and the land-based desalinated water distribution center are located less than 1 km apart.

15. The system of claim 1, wherein the desalination system further comprises a concentrate dilution system in which a concentrate produced in the desalination system can be diluted to yield a diluted concentrate prior to discharge into the body of water, the dilution system comprising a concentrate dilution container, an inlet for introducing concentrate into the dilution container, an inlet for introducing water from the body of water into the space, and an outlet for discharging the diluted concentrate from the container.

16. A method comprising the steps of:
(a) producing electricity and a heated exhaust by operating a gas turbine-powered electrical generator mounted on a structure positioned on the surface of a body of water; and
(b) on the structure, transferring heat from the heated exhaust to water to be desalinated.

17. The method of claim 16, wherein the step b of transferring heat from the heated exhaust to water to be desalinated causes the water to be desalinated to vaporize.

18. The method of claim 17, wherein the vaporized water is condensed to a liquid.

19. The method of claim 16, further comprising the steps of:
(c) conveying the produced electricity from the gas turbine-powered electrical generator mounted on a structure to a land-based desalinated electricity distribution center;
(d) on the structure, desalinating the water to be desalinated; and
(e) conveying the desalinated water from the structure to a land-based desalinated water distribution center.

20. The method of claim 17 wherein the step of desalinating water yields a concentrate and the method further comprises the steps of:
(f) diluting the concentrate to yield a diluted concentrate; and
(g) discharging the diluted concentrate into the body of water.
